(19) United States
(12) Patent Application Publication
(10) Pub. No.: US 2001/0029848 A1
(43) Pub. Date: Oct. 18, 2001

(54) Adjustable crown and edge drop control back-up roll

(76) Inventor: Herbert Lemper, McMurray, PA (US)

Correspondence Address: William L. Krayer, 1771 Helen Drive, Pittsburgh, PA, 15216, US

(21) Appl. No.: 09/730,087

(22) Filed: Dec. 5, 2000

Related U.S. Application Data
(60) Provisional application No. 60/169,579, filed on Dec. 8, 1999.

(51) Int. Cl. B30B 13/00

(52) U.S. Cl. 100/35

(57) ABSTRACT

The crown on a steel strip in a rolling mill is controlled by a continuous rotational adjustment of an arbor in response to a control signal representing the current crown profile or deviation therefrom, the arbor being equipped with a curved eccentric contour, bearing rollers surrounding the arbor and a continuous sleeve around the bearing rollers.

### RELATED APPLICATION

This application claims the benefit of my Provisional Application Ser. No. 60/169,579 filed Dec. 8, 1999, having the same title.

### TECHNICAL FIELD

This invention relates to rolling mills and particularly to methods and apparatus for crown control and avoiding edge drop.

### BACKGROUND OF THE INVENTION

Much of the effort of the art in the past in crown control has been directed to bending the work rolls or backup rolls to exert pressure on the center of the work surface. Bending of large rolls operating at high speed is difficult and requires massive machinery. Arbors and bendable rolls may be equipped with a sleeve as disclosed by Ginzburg in U.S. Pat. Nos. 4,813,258, 5,093,974 and 5,347,837. An early sleeve on a mandrel is shown by Fawell in U.S. Pat. No. 1,864,299. Various hydraulic systems have been used to flex a sleeve, either directly or indirectly, mounted on an arbor or other type of back-up device—see Bretschneider, U.S. Pat. No. 3,604,086, Lehman U.S. Pat. No. 3,879,827, Takigawa et al U.S. Pat. No. 4,242,781, Eibe U.S. Pat. No. 4,062,096, Biondetti U.S. Pat. No. 3,949,455, and Christ U.S. Pat. No. 4,059,976 (see FIG. 3 particularly).

Others have developed more direct mechanical methods of reinforcing the center of the work roll. See Gronbeck's hollow back-up roll which may be supported by discs (U.S. Pat. No. 4,407,151), the variable shaped back-up roll of Yoshii et al in U.S. Pat. No. 4,596,130, the variably controlled thrust load application devices of Matricon et al in U.S. Pat. No. 4,912,956 and Dominique in U.S. Pat. No. 4,882,922, and the fixed supports Guettinger describes in U.S. Pat. No. 4,414,889. Schnyder's hydrostatic support elements have bearing surfaces on inner traveling ring surfaces “deformed into a slightly elliptical shape”—col. 4, line 67. Ellis, in U.S. Pat. No. 4,676,085, controls the positions of hydraulic piston cylinder assemblies which act on an intermediate roll 24.

In U.S. Pat. No. 4,875,261, Nishida discusses prior art in which a back-up roll is equipped with cylindrical rollers between the roll shaft and an outer casing. He adds tapered roller bearings between the cylindrical rollers and an outer casing to receive a thrust load from the cylindrical rollers.

Negative and positive crowns are created by Verbickas according to U.S. Pat. No. 4,156,359, which shows eccentric cluster rolls in FIG. 2. The eccentric cluster rolls may be turned to vary the force on the surface of the working rolls. Masui et al, in U.S. Pat. No. 4,860,416, discloses a “variable crown” configuration employing tapered bearings between an arbor and a sleeve. While the “radial center of the inner peripheral surface of the inner race of each bearing is eccentric with respect to the radial center of outer peripheral surface of the inner race of the same bearing at the ends of the inner races” ('416 col 5 lines 21-25), this condition (see FIG. 16 of '416) is symmetrical around the entire bearing, i.e. there is no eccentricity or variation in the distance from the axis of the arbor to the outside of bearings. Tomizawa et al U.S. Pat. No. 5,007,152 is based on Masui and employs a curved arbor to vary the crown profile.

In PCT application PCT/US98/07789, I describe a combination of an arbor, concentric rings mounted on the arbor, and a sleeve enclosing the concentric rings together with roller bearings permitting the sleeve to turn against a work roll.

The art is still searching for a less costly and simple crown control system that can be operated using a single back-up roll.

### SUMMARY OF THE INVENTION

I have invented a back-up roll that will provide crown adjustment under full rolling load with maximum range, positive or negative, with a minimum application of external force. The back-up roll of this invention comprises mill-type components.

The back-up roll of this invention is based on an arbor machined to have an eccentric working surface, which is covered by a freely rotatable sleeve. Between the sleeve and the arbor is a plurality of bearing rollers substantially parallel to each other and the arbor. The arbor is continuously oriented to alter the crown profile in response to a continuous input signal which is a function of the product crown or its deviation from a desired crown set point or other set of conditions. Movement, i.e. the continuous rotational re-orientation of the arbor, and therefore the curvature of the working surface of the sleeve, may be effected by hydraulic, electric, or other known means for angularly positioning the arbor.

### BRIEF DESCRIPTION OF THE DRAWINGS

FIGS. 1a-1d represent a preferred embodiment of my invention.

FIG. 1a shows a section of the bearing rollers surrounding an arbor; the bearing rollers are in turn surrounded by a sleeve.

FIGS. 1b, 1c, 1d show sections through the arbor, bearing rollers and sleeve. Collectively, FIGS. 1a, 1b, 1c and 1d show the clearance 8 (exaggerated for illustration) between the bearing rollers and the sleeve.

FIGS. 2a-2b show an assembly 2a and an exploded view 2b to explain a preferred sequence of assembly of the component parts.

FIG. 3 shows all rolls of a roll stand. One adjustable crown back-up roll is shown with two working rolls in exaggerated distortion and a conventional back-up roll as the bottom roll. In addition, it shows the placement of the arbor-rotating mechanism.

FIGS. 4a, 4b, 4c, and 4d are side and sectional views of the bearing rollers and their placement surrounded by a sleeve.

FIGS. 5a-5d, 6a-6d, and 7a-7d show the different orientations of the curved axis eccentric arbor, demonstrating the change in crown due to rotation of the arbor.

FIGS. 8a-8d illustrate the edge drop problem and the use of my invention for controlling it.

### DETAILED DESCRIPTION OF THE INVENTION

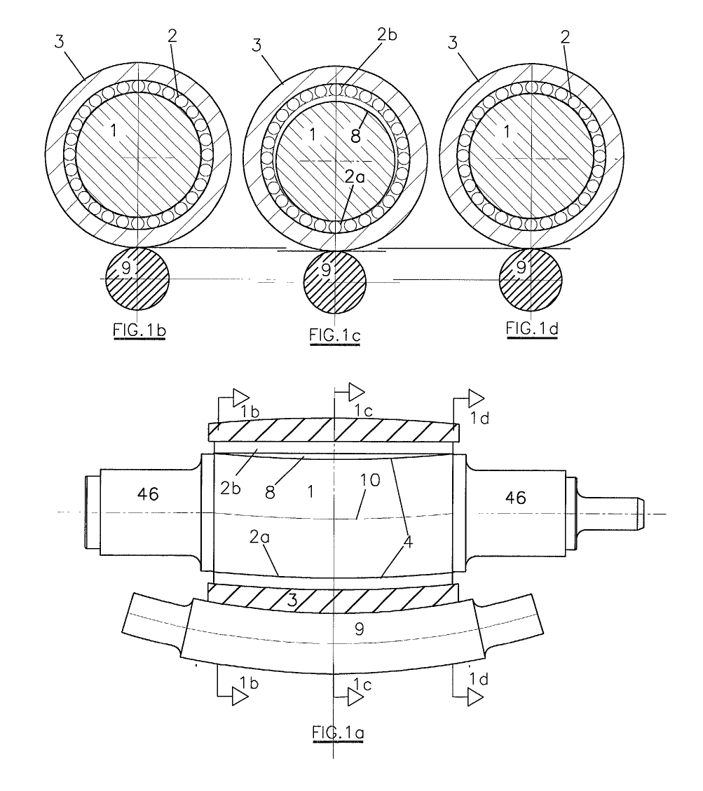

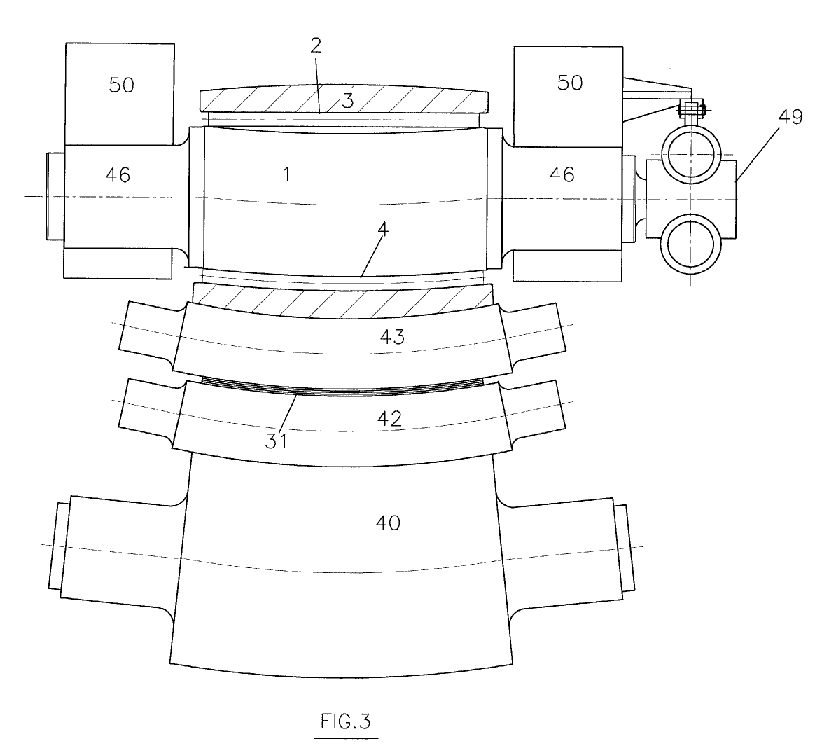

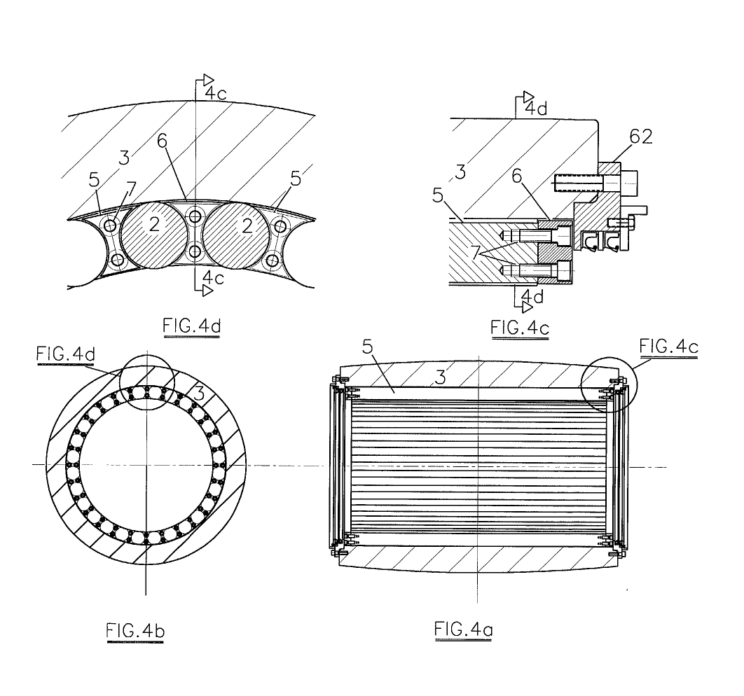

Referring now to FIG. 1a, bearing rollers 2 are seen to be deployed substantially parallel to arbor 1 and within sleeve 3. Arbor 1 has a curved axis 10 and curved surfaces 4. The profiles of curved surfaces 4 are preferably circular arcs of the same radius. As seen in FIG. 1a, application of the lower curved surface 4 results in the “maximum out” position for sleeve 3 (exaggerated as illustrated), correspondingly distorting working roll 9. As seen in FIG. 3, working roll 43 (comparable to working roll 9 in FIG. 1a) is in contact with the steel strip being rolled; in the “maximum out” position as shown, a crown on the strip will be more or less flattened. This effect is seen in sectional FIGS, 1b, 1c, and 1d; the central section of arbor 1 in FIG. 1c is lower than the sections of FIGS. 1b and 1d, which are taken near the ends of arbor 1. This results in a clearance 8 at the top of arbor 1. Roller spacers 5 (see FIG. 4d) between bearing rollers 2 maintain the bearing rollers 2 spaced and parallel. All spacers 5 are secured by pins 7 to end rings 6 (FIGS. 4c and 4d). Bearing rollers 2, roller spacers 5 with end rings 6 and pins 7 make a cage-like assembly as shown in FIG. 4a so that the bearing rollers 2 will be substantially axially aligned with the arbor 1.

Referring again to FIG. 1a, the dimensions of the curved eccentric contour of arbor 1 are greatly exaggerated for illustration, resulting in exaggerated curved surfaces 4 and curved axis 10 of arbor 1.

As indicated above, I prefer that both the upper and lower curved surfaces 4 of arbor 1 are of the same radius, but this is not essential—the arbor may, for example, deploy a toroidal or parabolic working profile or otherwise have complementary curvatures for the top and bottom curved surfaces 4 as depicted, resulting in “maximum in” and “maximum out” contours slightly different from those shown in FIG. 1a.

By an eccentric contour on the arbor, I mean the axis 10 and the two curved surfaces 4 preferably have the same curvature (radius length in the case of circular curves) but the radii have different points of origin and therefore the axis and the two curved surfaces 4 in the “maximum out” position are neither parallel nor concentric. The degree of eccentricity, which is determined by the radius length rather than the distance between the points of origin of the radii, will determine the “maximum out” profile desired for the crown of the back-up roll in contact with the work roll. The eccentricity of the arbor 1 is also discussed with reference to FIGS. 5a-5d, 6a-6d and 7a-7d. Toroidal, elliptical and parabolic contours (where the arbor axis may be depicted as curved accordingly) are also eccentric within my invention but are not preferred.

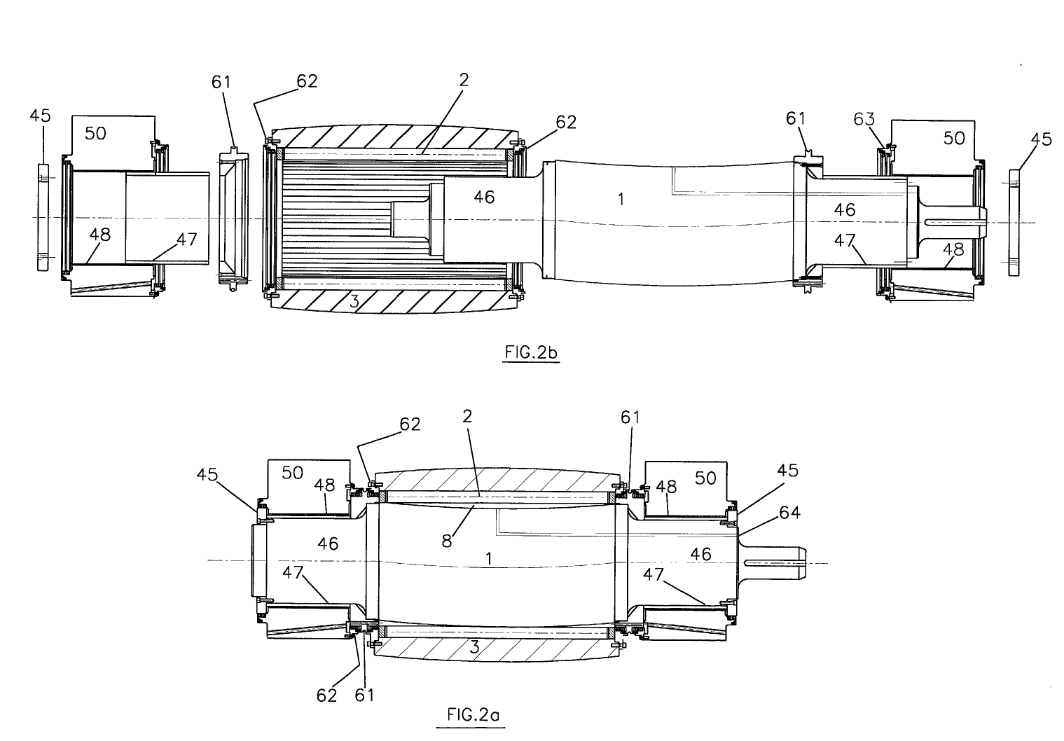

By a curved axis, I mean that the line formed by the points which are central and equidistant from the outside surface of arbor 1 is curved. In the case of the arbor 1 illustrated in FIG. 1a, the line will be neither parallel nor concentric with the curved surfaces 4 because the axis and both curved surfaces have the same radius. In the case of a toroidal form, the axis will be concentric with the two curved surfaces 4. Persons skilled in the art will observe from FIG. 2a and elsewhere herein that the actual rotation of arbor 1 is on a straight axis 30 as the arbor necks 46 reside in and are turned in more or less conventional chocks 50.

Clearance space 8 is shown in exaggerated proportion in FIGS. 1a and 1c. In a sleeve 3 having a nominal internal diameter of forty inches for example, the clearance space 8 would be no more than 0.04 inch if the maximum crown adjustment is 1000 micrometers, for example, but would vary considerably (plus or minus 50%) with the crown adjustment.

The sleeve 3 preferably has a built-in crown (not shown) made by grinding it to provide, for example, a center having a thickness of 500 micrometers greater than the thickness at the ends of the sleeve, the profile between the crown point and the end points being a circular arc (when the sleeve is not distorted by the arbor 1 and bearing rolls 2) determined by the three points at the ends and in the center of the sleeve 3. Thus the outside surface of sleeve 3 is in this variation slightly barrel-shaped. The “maximum in” position of the arbor having a 500 micrometer difference will, therefore, result in a flat profile for the external contact surface of such a sleeve with the working roll 9 (FIG. 1) or 43 (FIG. 3). The “maximum out” position will be assisted by the extra thickness of the sleeve and will therefore provide a crown effect twice the eccentricity of the arbor.

Orientation of arbor 1 and therefore adjustment of the crown profile, is continuously changed in response to a control signal, sometimes known as a shape signal, which is a function of the current product crown, as will be explained in more detail with reference to FIG. 3.

In FIG. 1a, the clearance space 8 is shown on the high sides of bearing rolls 2 and arbor 1 respectively because in use the clearance spaces are compressed on the lower portion of the assembly. In practice, the clearance space 8 permits relative ease of assembly. The deployment of 28 bearing rollers as illustrated in FIGS. 1b-1d is a preferred version of my invention. Any suitable number may be used; for an arbor diameter of 20 to 60 inches, a preferred range of bearing rollers is from about 18 to about 40.

At this point it is useful to observe the cage-like configuration of the array of bearing rollers as illustrated in FIGS. 4a-4d. The internal diameter of the more or less cylindrical cage-like configuration illustrated particularly in FIGS. 4a and 4b is slightly larger than the diameter of a section of arbor 1. Preferably the internal diameter of the cylinder formed by the innermost surfaces of the array of bearing rollers 2 is about equal to the sum of the diameter of a section of arbor 1 and clearance space 8, which may be seen clearly also in FIG. 1c. This slight difference in size simplifies the task of placing the bearing rollers on the arbor 1 when the apparatus of FIG. 4a is already assembled.

As seen in FIG. 2b, the arbor 1 may be inserted into the cage of bearing rollers 2 already surrounded by sleeve 3. Bearing rollers 2 are held in place by retainer rings 62 and spacer rings 61, as will be further explained with reference to FIGS. 4a-4d. Arbor roll necks 46 rest on neck sleeves 47 and 48 which in turn rest in chocks 50, and the arbor may be secured in place by retainer rings 45. The assembled back-up roll assembly is shown in FIG. 2a.

FIG. 2a illustrates a construction useful for rotating the arbor in response to a control signal which is a function of the crown of the current product, such as may be generated by a shapemeter or other device known in the art. The arbor necks 46 are equipped with neck sleeves 47 and outside sealing retainer rings 45. A bronze or babbitt liner 48 inside the chocks 50 provides a bearing surface to permit continuous rotating adjustment of the arbor 1. A hydraulic rotary actuator 49 (FIG. 3) is keyed to the arbor providing constant repositioning of the arbor by rotation to effect the crown adjustment, preferably through about 180° as a function of current product crown. The control system may be any suitable control system capable of providing desired maximum and minimum crown curvature positions and a gradual progression from one to the other. Any device that can provide rotation of the arbor may be used instead of a hydraulic rotary actuator, such as a gear drive powered by an electric or hydraulic motor. A lubricant duct 64 can be used to introduce lubricant to clearance 8.

FIG. 3 shows the effect of the invention in use. Arbor 1 has been turned by hydraulic rotary actuator 49 to an “out” position, meaning it has a downwardly oriented convexly curved surface 4 which distorts upper work roll 43 Workpiece 31, lower work roll 42, and lower back-up roll 40 are contiguous. In this illustration, sleeve 3 is slightly barrel-shaped, which adds to the curvature of arbor 1. As the strip or workpiece 31 moves between work rolls 42 and 43, sleeve 3 rotates on bearing rollers 2.

FIGS. 4a-4d show the assembled bearing rollers 2 held in place by retainer ring 62 (see also FIG. 2a). The enlargement of FIG. 4d shows spacers 5; they are further held in place by bolts 7.

In FIGS. 5a-5d, 6a-6d, and 7a-7d, the orientations of the preferred eccentric contour are shown in exaggerated form for explanation purposes. In FIG. 5d, the contour of the arbor 1 is oriented to achieve the “maximum out” effect illustrated by exaggerated arc 52. This arc is determined by selecting points 54, 55, and 56 having a desired distance d from the straight line 60; the circular arc 52 is part of the circle defined by those three points.

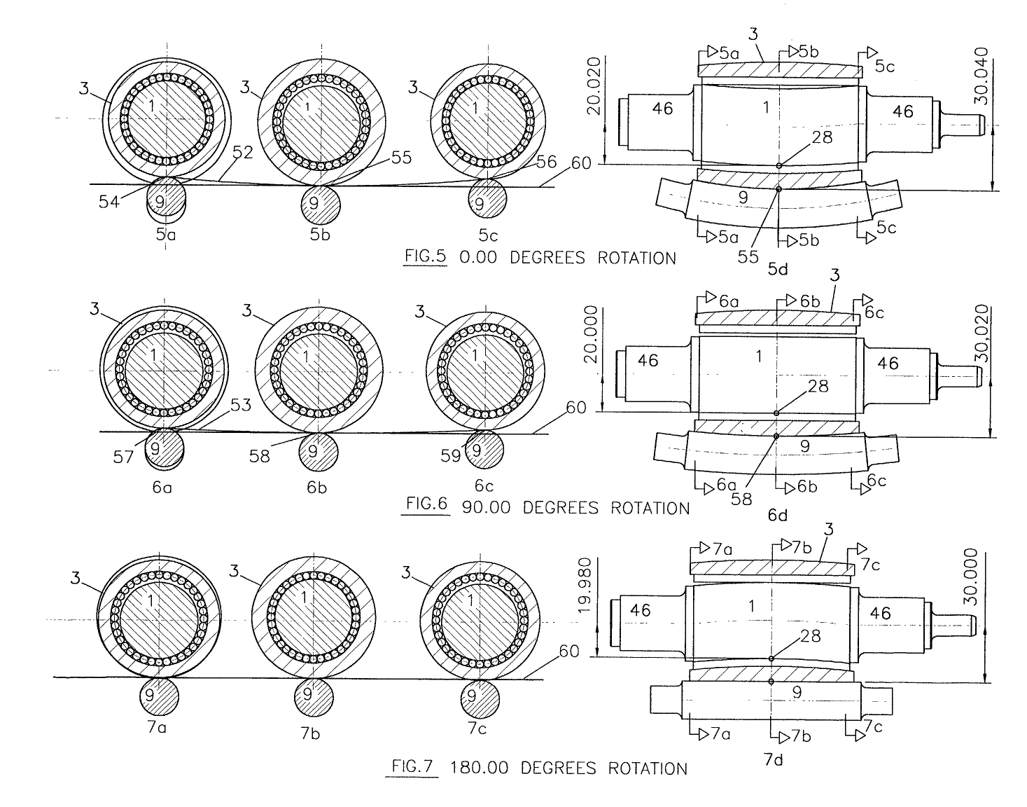

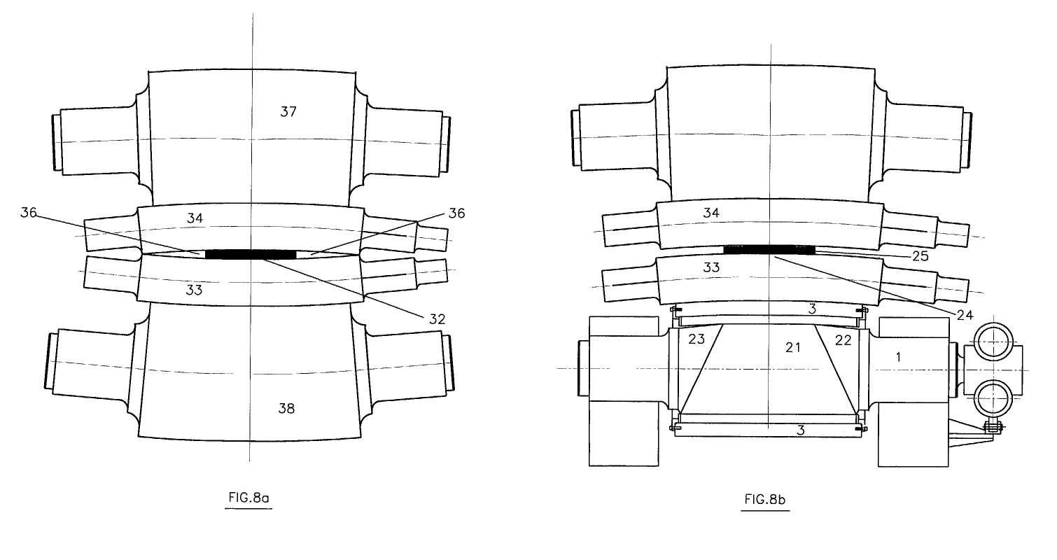

Likewise, when the arbor 1 is rotated 90° as depicted in FIG. 6d, points 57, 58, and 59 determine the circular arc 53, which represents the (exaggerated for illustration) slightly shallower profile of the “out” position. Note that in FIG. 7d, where the arbor 1 has been rotated 180°, sleeve 3 had been designed to straighten the profile along line 60.

Note that the center point 28 of arbor 1 is lowest in FIG. 5d, is central in FIG. 6d, and is highest in FIG. 7d. In a preferred version of my invention, the vertical position of center point 28 changes during rotation from 20.020″ as shown in FIG. 5d to 20.000″ as shown in FIG. 6d to 19.980″ as shown in FIG. 7d. As mentioned above in connection with FIG. 3, my back-up roll assembly may be used in both lower and upper positions in a roll stand. In the variation of FIGS. 5-7, 36 bearing rollers are illustrated.

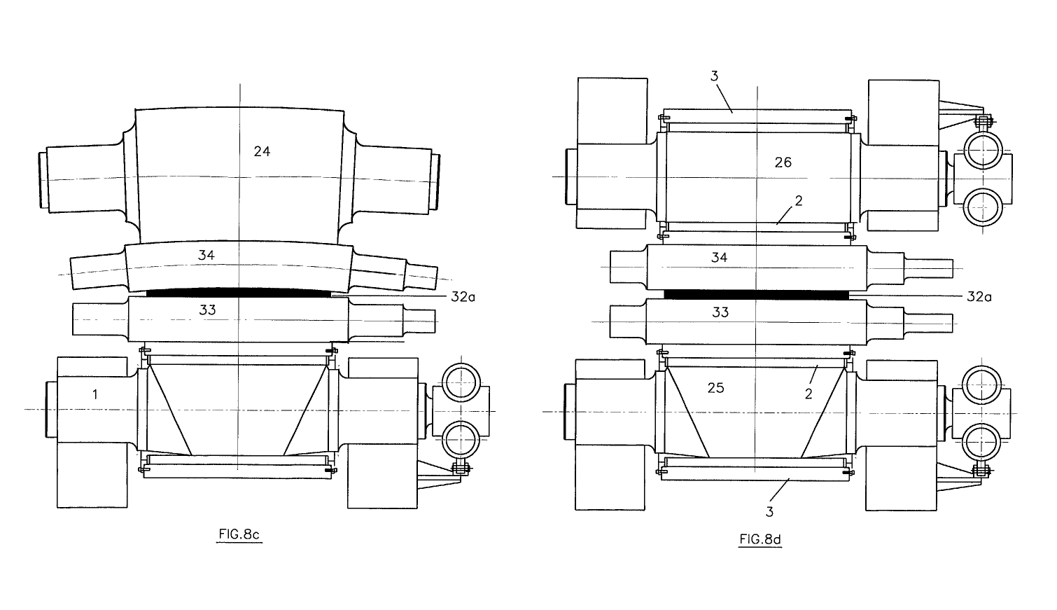

Referring now to FIG. 8a, the problem of “edge drop” is illustrated in exaggerated fashion. A strip or other workpiece 32 of a width substantially less than work rolls 33 and 34 forms free spaces 36 which permit work rolls 33 and 34, and the conventional back-up rolls 37 and 38, to bend, compressing the edges of workpiece 32.

My sleeve and bearing rollers aligned with the arbor may be used to solve the edge roll problem easily and with adaptability for all widths, using a specially designed arbor. FIG. 8b shows an arbor 1 having a generally cylindrical surface 21 which has been machined to remove triangular (as depicted) areas 22 and 23 so that when the arbor 1 is rotated, varying lengths of working surfaces will be presented to sleeve 3. In the case illustrated, the working surface 24 is the same length as workpiece 25, so there is no distortion of the work roll 33.

In FIG. 8c, the same arbor 1 has been rotated 180° in a manner explained elsewhere herein to accommodate the full-width workpiece 32a.

While the back-up roll 24 of FIG. 8c is conventional, FIG. 8d has an edge drop correction back-up roll 25 on the bottom and a crown control back-up roll assembly 26 on the top. Each back-up roll 25 and 26 has a sleeve 3 and bearing rollers 2 as described throughout. Thus the roll stand of FIG. 8d not only controls crown variation but also avoids edge drop.

I claim:

1. A crown control back-up roll assembly for a rolling mill comprising an arbor having an eccentric contour on a curved axis, a sleeve surrounding said arbor, and a plurality of bearing rollers substantially axially aligned with said arbor between said sleeve and said arbor.

2. A crown control back-up roll assembly of claim 1 including means for continuously adjusting the angular position of said arbor and through about 180 degrees as a function of current product crown.

3. A crown control back-up roll assembly of claim 1 wherein said contour is deployed on said arbor to achieve maximum convex crown curvature at a first position and is rotatable with said arbor to achieve a minimum crown curvature at a second position.

4. A crown control back-up roll assembly of claim 3 wherein said maximum and minimum crown contours have the shape of substantially circular arcs.

5. A crown control back-up roll assembly comprising a sleeve, an arbor within said sleeve, and a plurality of bearing rollers on the internal surface of said sleeve for supporting the rotation of said sleeve said bearing rollers being substantially the length of said sleeve and said arbor and being substantially axially aligned with said sleeve and said arbor.

6. A crown control back-up roll assembly of claim 5 having a clearance space between said arbor and said bearing rollers.

7. A crown control back-up roll assembly of claim 5 having a clearance space between said bearing rollers and said sleeve.

8. A crown control back-up roll assembly of claim 5 wherein said sleeve has a substantially cylindrical internal surface and a slightly barrel-shaped external surface, and wherein a transverse section of said barrel-shaped external surface taken in the same plane as the axis of said sleeve will exhibit a substantially circular arc based on points at the two ends of said external surface and the central crown point.

9. A crown control back-up roll assembly of claim 5 wherein said eccentric contour is deployed on said arbor to effect positive and negative circular arc crown profiles within an angular range of zero to 180°.

10. A crown control back-up roll assembly of claim 5 wherein said bearing rollers are held in place by retainer rings at the ends thereof.

11. A method of controlling crown formation in metal rolling comprising (a) rolling said metal against a working roll having as a back-up roll a sleeve, an arbor having an eccentric contour within said sleeve, and a series of bearing rollers on and substantially aligned with said arbor, for shaping the surface of said sleeve in contact with said working roll, (b) generating a control signal representing the current product crown profile, and (c) continuously adjusting the angular position of said arbor in response to said signal.

12. Method of claim 11 wherein a second working roll has a back-up roll comprising a sleeve and an arbor having an eccentric contour within said sleeve, and a series of bearing rollers on said arbor for contacting the internal surface of said sleeve.

13. Method of claim 11 wherein there is an intermediate roll between said sleeve and said working roll.

14. A back-up roll assembly of claim 5 including a rotator for said arbor, said rotator being continuously responsive to a signal which is a function of deviation of the current product crown from a desired crown.

15. A back-up roll assembly for use in edge drop control comprising (a) a substantially cylindrical arbor having a working surface which varies in width as a function of the angular orientation of said arbor (b) a sleeve over the length of said arbor and providing a contact surface effected through said bearing rollers and said sleeve for contacting a work roll (c) bearing rollers substantially aligned with said arbor, surrounding said arbor and enclosed within said sleeve, and (d) means for turning said arbor as a function of the width of a workpiece in need of edge drop control.

16. A roll stand including a back-up roll assembly of claim 1 and a back-up roll assembly of claim 16.
